(19) United States
(12) Patent Application Publication
(10) Pub. No.: US 2026/0300858 A1
(43) Pub. Date: Oct. 1, 2026

(54) WORK SUPPORT SYSTEM

(71) Applicant: Toyota Jidosha Kabushiki Kaisha, Toyota-shi (JP)

(72) Inventor: Keisuke MIURA, Toyota-shi (JP)

(73) Assignee: Toyota Jidosha Kabushiki Kaisha, Toyota-shi (JP)

(21) Appl. No.: 19/457,696

(22) Filed: Jan. 23, 2026

(30) Foreign Application Priority Data
Mar. 31, 2025 (JP) 2025-057977

(51) Int. Cl. G06Q 10/0631; G01D 21/02

(52) U.S. Cl. CPC G06Q 10/063114; G01D 21/02

(57) ABSTRACT

A work support system includes a first sensor device that acquires a magnitude of a force acting on a body of a worker, a second sensor device that acquires an external shape state of a part of the body on which the force acts, a display unit that displays an image, and a controller that controls the work support system. The controller is configured to display, on the display unit, a state image representing the external shape state generated based on an output of the second sensor device, and a force image representing at least one of a magnitude of the force acting on the body of the worker determined based on an output of the first sensor device or a direction of the force acting on the body of the worker determined based on an output of the second sensor device.

### CROSS-REFERENCE TO RELATED APPLICATION

This application claims priority to Japanese Patent Application No. 2025-057977 filed on Mar. 31, 2025. The disclosure of the above-identified application, including the specification, drawings, and claims, is incorporated by reference herein in its entirety.

### BACKGROUND

### 1. Technical Field

The present disclosure relates to a work support system.

### 2. Description of Related Art

In the related art, there is a system that recognizes a person’s action. An action recognition system of Japanese Unexamined Patent Application Publication No. 2018-147153 (JP 2018-147153 A) reads a value from a sensor and performs action recognition using the value. The sensor may be a video camera fixed to a ceiling, smart glasses capable of acquiring a first-person image of a wearer, or eye-tracking glasses capable of obtaining position information of a gaze point of the wearer. In addition, the sensor may be a distance sensor, a microphone, an acceleration sensor, a gyro sensor, a sensor that measures a physiological index such as a pulse, a heart rate, and a myoelectric potential, or a mat that measures pressure. The action recognition system displays a result of the action recognition to a user of the action recognition system.

### SUMMARY

However, in the technique described in JP 2018-147153 A, an action executed by a person is recognized, and merely a result of the recognition is displayed. That is, a magnitude of a force to be applied, a direction of the force, or an external shape state of a body that should be referred to when a person tries to take the same action as the action is not displayed. Therefore, a worker who should perform a specific work cannot use the information as a reference for appropriately performing the work.

The present disclosure can be implemented as the following aspects.

(1) According to an aspect of the present disclosure, a work support system is provided. The work support system includes

a first sensor device configured to acquire a magnitude of a force acting on a body of a worker,

a second sensor device configured to acquire an external shape state of a part of the body on which the force acts,

a display unit configured to display an image, and

a controller configured to control the work support system.

The controller is configured to display, on the display unit,

a state image representing the external shape state, the state image being generated based on an output of the second sensor device, and

a force image representing at least one of a magnitude of the force acting on the body of the worker determined based on an output of the first sensor device and a direction of the force acting on the body of the worker determined based on the output of the second sensor device.

With such an aspect, the worker can easily understand the magnitude and the direction of the force applied during the work through the display unit. As a result, in a case of performing a certain work, the worker can use a display of the display unit as a reference for performing appropriate work.

(2) In the work support system according to the aspect,

the controller may be configured to display, on the display unit,

an image having at least one of a size corresponding to the magnitude of the force and a color corresponding to the magnitude of the force, as the force image.

With such an aspect, the user can intuitively understand the magnitude of the force that is inherently invisible through the displayed image.

(3) In the work support system according to the aspect,

the second sensor device may include a camera configured to image a predetermined range including a hand of the worker, and

the controller may be configured to simultaneously display, on the display unit,

an image captured by the second sensor device as the state image,

an orientation image representing an orientation of a tool held by the hand of the worker as the force image, and

a target image representing a target of the orientation of the tool.

With such an aspect, the worker can perform appropriate work based on the orientation image and the target image displayed on the display unit.

(4) In the work support system according to the aspect,

the second sensor device may include a plurality of acceleration sensors attached to clothing worn by the worker, and

the controller may be configured to display, on the display unit, a skeleton display of the worker generated based on the output of the second sensor device, as the state image.

With such an aspect, the worker can understand the external shape state of the worker’s body from the state image without being affected by a color or a pattern of the clothing, a shadow of the clothing, or the like, unlike a case where the state image is an image captured by the camera.

The present disclosure can also be implemented in various forms other than the work support system. For example, the present disclosure can be implemented in a form of a work support method, a control method of a work support device, a computer program that implements the method, or a non-transitory recording medium on which the computer program is recorded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram showing a configuration of a work support system 10;

FIG. 2 is an explanatory diagram showing a flow of data in the work support system 10;

FIG. 3 is a diagram showing an example of an image displayed on a display unit 600 by a controller 900;

FIG. 4 is a diagram showing an example of an image displayed on the display unit 600 by the controller 900;

FIG. 5 is a diagram showing an example of an image displayed on the display unit 600 by the controller 900; and

FIG. 6 is a diagram showing an aspect in which a point Et at which a worker WK is looking is displayed in a superimposed manner on an image Ista captured by a process camera 210 on the display unit 600.

### DETAILED DESCRIPTION OF EMBODIMENTS

### A. Embodiment

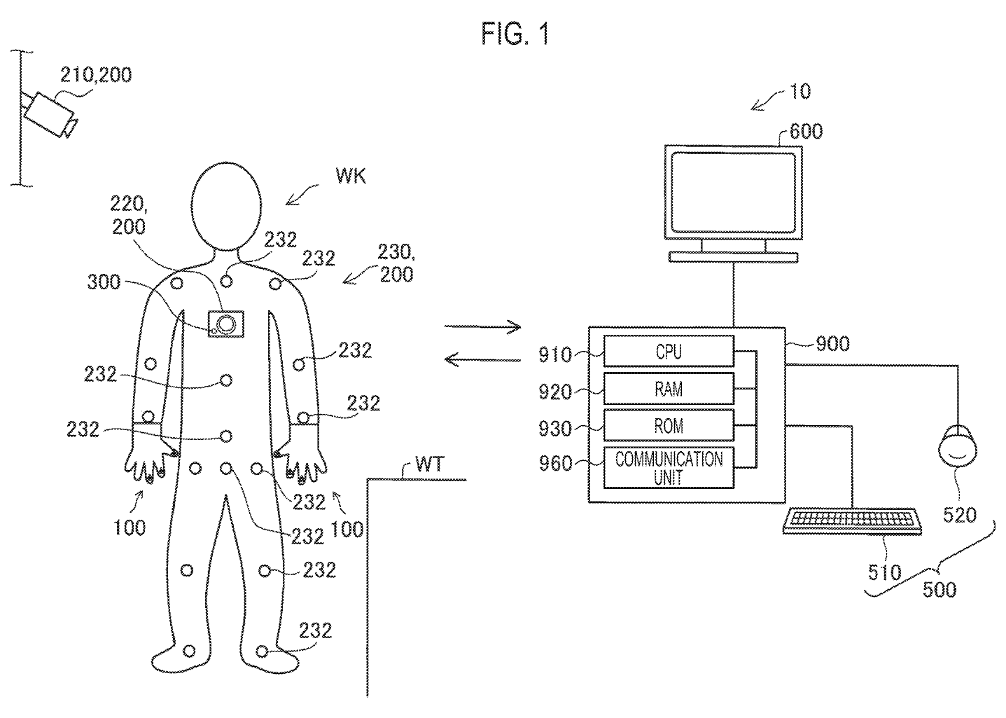

FIG. 1 is an explanatory diagram showing a configuration of a work support system 10. The work support system 10 is a system that supports work performed by a worker WK. More specifically, the work support system 10 is a system that supports the worker WK to bring the magnitude and the direction of the force to be applied by the worker WK in the work closer to the target. The work support system 10 includes a first sensor device 100, a second sensor device 200, a third sensor device 300, a display unit 600, an input unit 500, and a controller 900.

The first sensor device 100 is a device that acquires the magnitude of the force acting on the body of the worker WK (see a middle left portion of FIG. 1). The first sensor device 100 includes a sensor that measures the magnitude of the force acting on a part of the hand of the worker WK. More specifically, the first sensor device 100 includes pressure sensors disposed on a thumb, an index finger, and a middle finger of each of the left and right hands of the worker WK. In FIG. 1, the pressure sensor is indicated by a black triangle. Each pressure sensor detects the magnitude of the force applied to each pressure sensor. Each pressure sensor is provided on a thumb portion, an index finger portion, and a middle finger portion of a glove worn by the worker WK. The glove on which the pressure sensor is provided is also referred to as a “sensor glove”. In the first sensor device 100, each detected value is associated with a time point at which the value is detected. The first sensor device 100 transmits data D100 representing the magnitude of the force associated with the time point to the controller 900 by wireless communication (see an arrow in a middle center portion of FIG. 1).

The second sensor device 200 is a device that acquires the external shape state of the part of the body of the worker WK on which the force acts (see a left portion of FIG. 1). The second sensor device 200 transmits the acquired data to the controller 900 by wireless communication. The second sensor device 200 includes a process camera 210, a chest camera 220, and a workwear sensor 230.

The process camera 210 images a predetermined range including the hand of the worker WK (see an upper left portion of FIG. 1). The process camera 210 is a digital video camera that is disposed such that the entire work area in which a certain process is executed by the worker WK is included in an angle of view in the factory. The process camera 210 is fixed to a column in the factory. The process camera 210 is installed such that the first sensor device 100 worn by the worker WK, the workwear sensor 230, and the workbench WT used for the work are consistently included in the angle of view of the process camera 210 while the process is being executed. The process camera 210 is further installed such that the above-described condition is satisfied for a plurality of work areas of a plurality of workers who execute the same process.

An image Ista captured by the process camera 210 is associated with a time point at which the image is captured. The process camera 210 transmits data D210 representing the image Ista associated with the time point to the controller 900 by wireless communication (see an arrow in a middle center portion of FIG. 1).

The chest camera 220 images a predetermined range including the hand of the worker WK (see a middle left portion of FIG. 1). The chest camera 220 is a digital video camera that is disposed such that the entire work area in which a certain process is executed by the worker WK is included in an angle of view. The chest camera 220 is fixed to a chest belt worn by the worker WK. The chest camera 220 is also referred to as a “work viewpoint camera”. The chest camera 220 is fixed to the worker WK such that the first sensor device 100 worn by the worker WK and the workbench WT are consistently included in the angle of view of the chest camera 220 while the process is being executed.

An image Istb captured by the chest camera 220 is associated with a time point at which the image is captured. The chest camera 220 transmits data D220 representing the image Istb associated with the time point to the controller 900 by wireless communication (see an arrow in a middle center portion of FIG. 1).

The workwear sensor 230 acquires the acceleration, the angular velocity, and the orientation of each part of the body of the worker WK (see a left portion of FIG. 1). The workwear sensor 230 includes a plurality of acceleration sensors attached to the clothing worn by the worker WK. Specifically, the workwear sensor 230 includes an inertial measurement unit (IMU) 232 disposed at a plurality of parts of the body of the worker WK including a plurality of joints. In FIG. 1, each IMU 232 is indicated by a circle. The IMU 232 is fixed to a chest, an abdomen, and a waist of the worker WK, and to shoulder joint parts, elbow joint parts, wrist parts, thigh root parts, knee joint parts, shin parts, ankle parts, and the like of the left and right sides.

The IMU 232 includes an acceleration sensor, a gyro sensor, and a geomagnetic sensor. The acceleration sensor detects the magnitude of the acceleration in the x, y, and z axis directions of the sensor coordinate system of the IMU 232. The gyro sensor detects the magnitude of the angular velocity in the x, y, and z axis directions of the sensor coordinate system of the IMU 232. The geomagnetic sensor detects the magnitude of the geomagnetic field in the x, y, and z axis directions of the sensor coordinate system of the IMU 232.

As a result, the IMU 232 can detect the magnitude and the orientation of the acceleration of the IMU 232, the magnitude and the orientation of the angular velocity, and the orientation of the geomagnetic field in the sensor coordinate system. The IMU 232 can detect the magnitude and the orientation of the velocity of the IMU 232, the position, and the posture in the sensor coordinate system based on these values. The detection value detected by the workwear sensor 230 is associated with a time point at which the value is detected. The workwear sensor 230 transmits data D230 representing the detection value associated with the time point to the controller 900 by wireless communication (see an arrow in a middle center portion of FIG. 1).

The third sensor device 300 is a sensor for acquiring a sound around the worker WK (see a middle left portion of FIG. 1). The third sensor device 300 is fixed to the chest belt worn by the worker WK, together with the chest camera 220. The third sensor device 300 is a microphone that is configured and disposed to record a sound generated due to work included in the process while the process is being executed by the worker WK. The detection value detected by the third sensor device 300 is associated with a time point at which the value is detected. The third sensor device 300 transmits data D300 representing the sound associated with the time point to the controller 900 by wireless communication.

The display unit 600 is controlled by the controller 900 to display an image (see an upper right portion of FIG. 1). In the present specification, the “image” includes characters and symbols. Specifically, the display unit 600 is a liquid crystal display.

The controller 900 controls the work support system 10 (see a middle right portion of FIG. 1). The controller 900 is a computer including a central processing unit (CPU) 910 that is a processor, a random access memory (RAM) 920, a read-only memory (ROM) 930, and a communication unit 960. The RAM 920 includes a main memory, a hard disk that is an auxiliary storage device, and a solid state drive (SSD). The hard disk stores an operating system, an application program that controls the work support system 10, data processed by the operating system and the application program, and the like. The CPU 910 loads and executes a computer program stored in the hard disk in the main memory to implement various functions of the work support system 10. The communication unit 960 performs wireless communication with the first sensor device 100, the second sensor device 200, and the third sensor device 300 under the control of the CPU 910.

The input unit 500 is operated by a user of the work support system 10 to input information to the controller 900 (see a lower right portion of FIG. 1). The input unit 500 includes a keyboard 510 and a mouse 520.

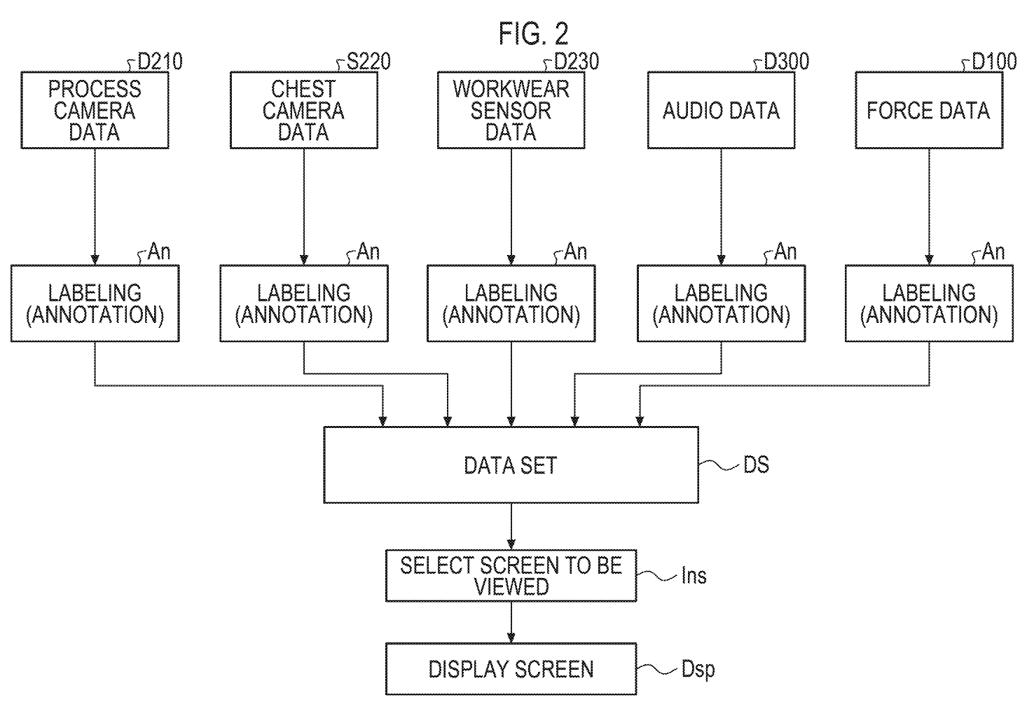

FIG. 2 is an explanatory diagram showing a flow of data in the work support system 10. The first sensor device 100, the process camera 210, the chest camera 220, the workwear sensor 230, and the third sensor device 300 acquire data in synchronization with each other. For example, the first sensor device 100 and the workwear sensor 230 acquire detection data at a predetermined period. The process camera 210, the chest camera 220, and the third sensor device 300 acquire detection data at a period that is 1/n of an integer of a data acquisition period of the first sensor device 100 and the workwear sensor 230. The detection data D100 of the first sensor device 100, the detection data D210 of the process camera 210, and the detection data D220 of the chest camera 220 are transmitted to the controller 900, respectively. In addition, the detection data D230 of the workwear sensor 230 and the detection data D300 of the third sensor device 300 are also transmitted to the controller 900 (see an upper portion of FIG. 2 and a middle center portion of FIG. 1).

The CPU 910 of the controller 900 performs an annotation An on data associated with the time points included in the detection data D100, D210, D220, D230, and D300, respectively (see a middle portion of FIG. 2). Specifically, the CPU 910 performs processing based on the detection data D210 of the process camera 210, the detection data D220 of the chest camera 220, and the detection data D300 of the third sensor device 300. In this processing, one or more works executed in a time interval in which the detection data is acquired are specified. The work includes, for example, a screw taken out from a screw placement, a temporary screwing, a main screwing, and a component fitting.

For example, the detection data D300 of the third sensor device 300 includes a “click” sound of the component fitting or an operation sound of the electric driver when the component fitting is completed. The CPU 910 of the controller 900 uses an image at each time point included in the detection data D210 of the process camera 210 and the detection data D220 of the chest camera 220. In addition, a sound at each time point included in the detection data D300 of the third sensor device 300 is also used. Based on these, one or more works executed in the time interval in which the detection data is acquired are specified.

The CPU 910 uses a time point associated with each image included in the detection data D210 of the process camera 210 and the detection data D220 of the chest camera 220. In addition, a time point associated with the sound included in the detection data D300 of the third sensor device 300 is also used. Based on these, a start time point and an end time point are determined for each of the plurality of works included in the process. The CPU 910 acquires data of the detection values in the detection data D100, D210, D220, D230, and D300 associated with the time point included between the determined start time point and end time point. The CPU 910 associates the information representing the work executed in the time interval. This work is referred to as “annotation” or “labeling” (see a middle portion of FIG. 2).

The CPU 910 of the controller 900 checks the data of the detection values included in the detection data D100, D210, D220, D230, and D300, respectively. Among these, data associated with the same work is combined. With this combination, a data set DS of each work is created (see a middle portion of FIG. 2). That is, the data set DS of one work includes an output data group detected by the first sensor device 100, an output data group detected by the process camera 210, and an output data group detected by the chest camera 220. In addition, the data set DS of one work also includes an output data group detected by the workwear sensor 230 and an output data group detected by the third sensor device 300. The data set DS of one work further includes data that can specify the work.

The CPU 910 displays, on the display unit 600, a list of names of the work for which the corresponding data set DS is created, together with information representing a screen on which the display unit 600 can display. The screen that can be displayed on the display unit 600 is (i) to (vi). The following (i) to (vi) can be independently selected to be displayed or not displayed.
(i) a state image that is generated based on the output of the process camera 210 and that represents the external shape state of the part of the body of the worker WK;
(ii) a state image that is generated based on the output of the chest camera 220 and that represents the external shape state of the part of the body of the worker WK;
(iii) a force image that is determined based on the output of the first sensor device 100 and that represents the magnitude of the force acting on the body of the worker WK;
(iv) a force image that is determined based on the outputs of the process camera 210 and the chest camera 220 and that represents the direction of the force acting on the body of the worker WK;
(v) a graph including a force image that represents the magnitude of the force acting on the body of the worker, the graph showing a temporal change in the detection value of the first sensor device 100, the detection value of the workwear sensor 230, and the detection value of the third sensor device 300; and
(vi) a skeleton display as a state image that is determined based on the output of the workwear sensor 230 and that represents the posture of the worker WK.

The user selects an image to be viewed from the above (i) to (vi), and inputs an instruction Ins indicating the selected image to the controller 900 via the input unit 500 (see a lower portion of FIG. 2). Thereafter, processing Dsp of displaying the image corresponding to the instruction Ins on the display unit 600 is executed (see a lower portion of FIG. 2).

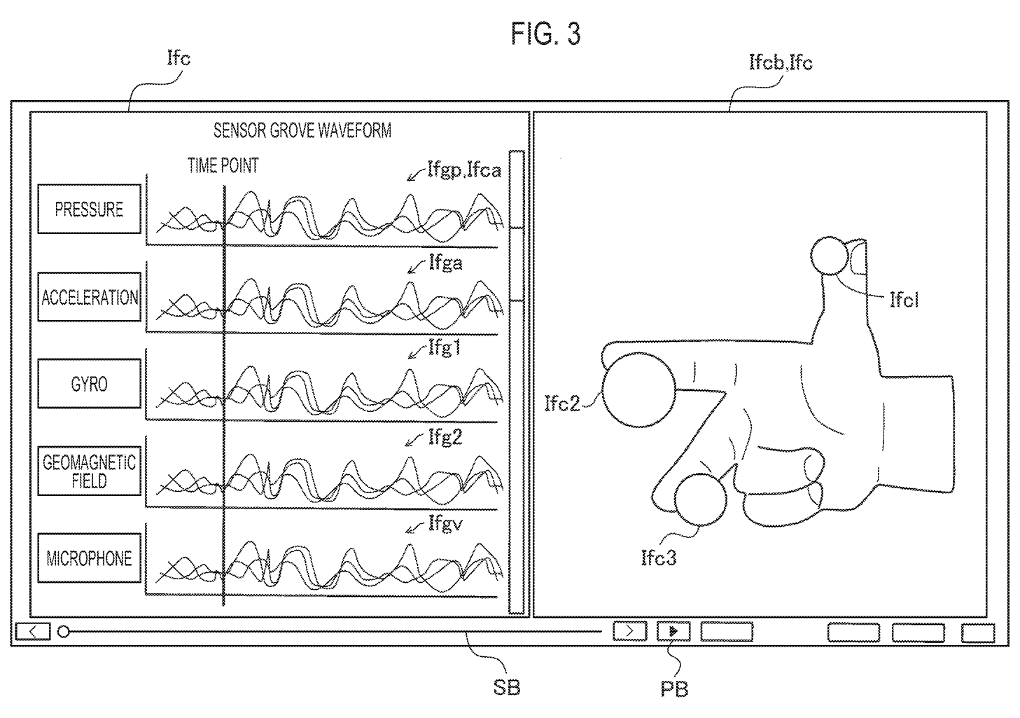

FIG. 3 is a diagram showing an example of the image displayed on the display unit 600 by the controller 900. FIG. 3 shows an example of the image displayed on the display unit 600 in a case where the user selects the above (v) and the above (iii). A left portion of FIG. 3 shows a graph Ifca showing a temporal change in the detection value of the first sensor device 100, the detection value of the workwear sensor 230, and the detection value of the third sensor device 300.

A graph Ifgp is a graph showing a temporal change in the force applied to each finger as a force image Ifca representing the magnitude of the force acting on the body of the worker. The graph Ifga is a graph showing a temporal change in the acceleration of the wrist in the x, y, and z directions. The graph Ifg1 is a graph showing a temporal change in the angular velocity of the wrist around the x, y, and z axes. The graph Ifg2 is a graph showing a temporal change in the geomagnetic field of the wrist in the x, y, and z directions. The graph Ifgv is a graph showing a temporal change in the magnitude of the sound around the worker WK.

In the graph Ifca, a bar representing a specific time point is shown. This bar indicates the time point of the force image Ifcb shown in a right portion of FIG. 3. By dragging the display representing the time point corresponding to the position of the bar in the slide bar SB to the left and right with the mouse 520, the bar is moved to the left and right.

In a right portion of FIG. 3, a force image Ifcb including circles Ifc1, Ifc2, and Ifc3 having a size corresponding to the magnitude of the force is displayed as the force image Ifc representing the magnitude of the force acting on the body of the worker WK, together with a still image of the hand. The sizes of the circles Ifc1, Ifc2, and Ifc3 can be changed by moving the bar representing the specific time point in the graph Ifca in the left portion of the screen to the left and right. That is, the circles Ifc1, Ifc2, and Ifc3 of the force image Ifcb represent the magnitude of the force applied to each finger at the time point represented by the bar (see Ifgp in an upper left portion of FIG. 3). In addition, by the user clicking a playback button PB, the circles Ifc1, Ifc2, and Ifc3 representing the magnitude of the force at each time point are continuously displayed as a video in response to the elapse of time.

By performing such processing, the user can intuitively ascertain the magnitude of the force that is originally invisible through the displayed circles Ifc1, Ifc2, and Ifc3.

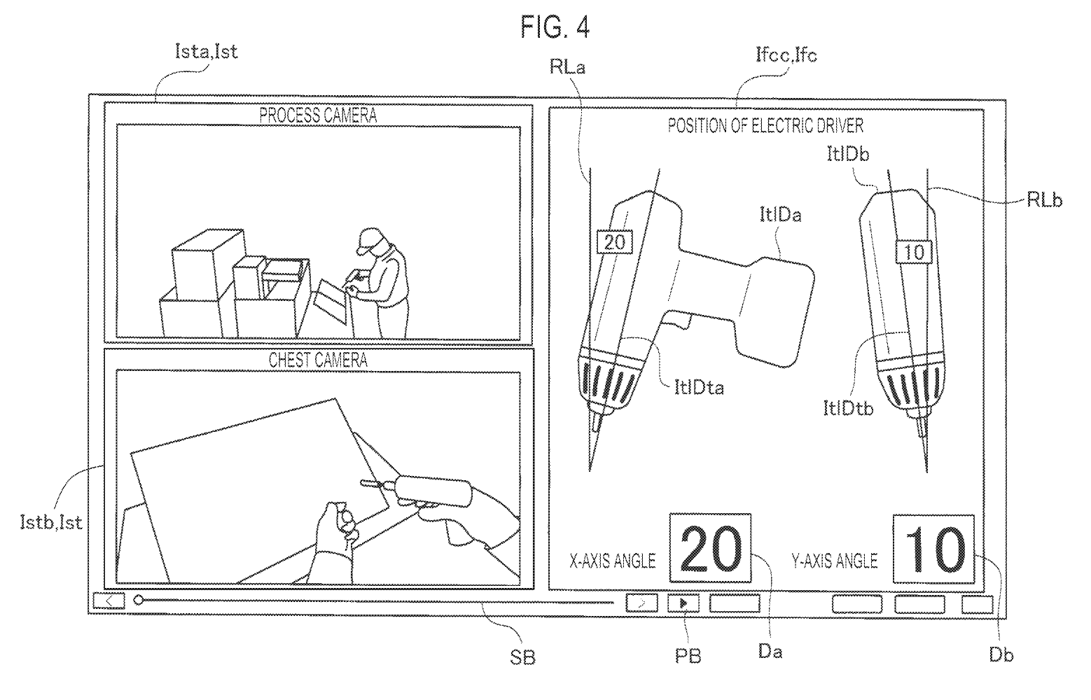

FIG. 4 is a diagram showing an example of the image displayed on the display unit 600 by the controller 900. FIG. 4 shows an example of the image displayed on the display unit 600 in a case where the user selects the above (i), the above (ii), and the above (iv). In FIG. 4, an example of the screwing work of the screw by the electric driver is shown. In a left portion of FIG. 4, an image captured by the second sensor device 200 is shown as the state image Ist representing the external shape state. More specifically, in an upper left portion of FIG. 4, an image Ista captured by the process camera 210 is shown as the state image Ist. In a lower left portion of FIG. 4, an image Istb captured by the chest camera 220 is shown as the state image Ist. For ease of understanding the technology, the image Ista captured by the process camera 210 shows only the work performed by one worker (see the upper left portion of FIG. 4).

In a right portion of FIG. 4, orientation images ItlDa and ItlDb representing the orientation of the tool held by the hand of the worker WK and target images ItlDta and ItlDtb representing the target of the orientation of the tool are displayed. The image ItlDa is an image showing the inclination of the electric driver with respect to the front-rear direction of the worker WK (see a middle right portion of FIG. 4). The image ItlDb is an image showing the inclination of the electric driver with respect to the left-right direction of the worker WK. The front-rear direction of the worker WK and the left-right direction of the worker WK are determined in the absolute coordinate system according to the work standard.

The image ItlDta is an image showing an ideal inclination of the electric driver with respect to the front-rear direction of the worker WK (see a middle center portion of FIG. 4). The image ItlDtb is an image showing an ideal inclination of the electric driver with respect to the left-right direction of the worker WK. The line RLa and the line RLb are images showing the vertical direction (see the middle center portion and the middle right portion of FIG. 4). The numerical value Da is an image showing the magnitude of the ideal inclination of the electric driver from the vertical direction with respect to the front-rear direction of the worker WK (see a lower center portion of FIG. 4). The numerical value Db is an image showing the magnitude of the ideal inclination of the electric driver from the vertical direction with respect to the left-right direction of the worker WK (see a lower right portion of FIG. 4).

In the screwing work of the screw by the electric driver, the force acting on the body of the worker WK is a reaction force received from the electric driver. The direction of the force acting on the body of the worker WK is the orientation of the electric driver. Therefore, the images ItlDa and ItlDb can also be understood as the force image Ifcc in which the direction of the force acting on the body of the worker WK is displayed.

In a case where the above (i), the above (ii), and the above (iv) are selected, as shown in FIG. 4, the images Ista and Istb captured by the second sensor device 200 as the state image Ist are used. In addition, the orientation images ItlDa and ItlDb representing the orientation of the tool held by the hand of the worker WK and the target images ItlDta and ItlDtb representing the target of the orientation of the tool are also used. These images are simultaneously displayed on the display unit 600. By the user clicking the playback button PB, the images Ista, the image Istb, and the force image Ifcc at each time point in response to the elapse of time are continuously displayed as a video.

By performing such processing, the worker WK can perform appropriate work based on the orientation images ItlDa and ItlDb and the target images ItlDta and ItlDtb displayed on the display unit 600. For example, in a case where a new worker learns the work by watching the work of the skilled worker, the hand actually performing the work may not be visible due to the body of the skilled worker. In addition, the work manual does not show the magnitude and the direction of the force in detail for all the work. However, by performing the processing shown in FIGS. 2 and 4, the new worker can recognize the difference between the work of the new worker himself/herself and the target, and can learn.

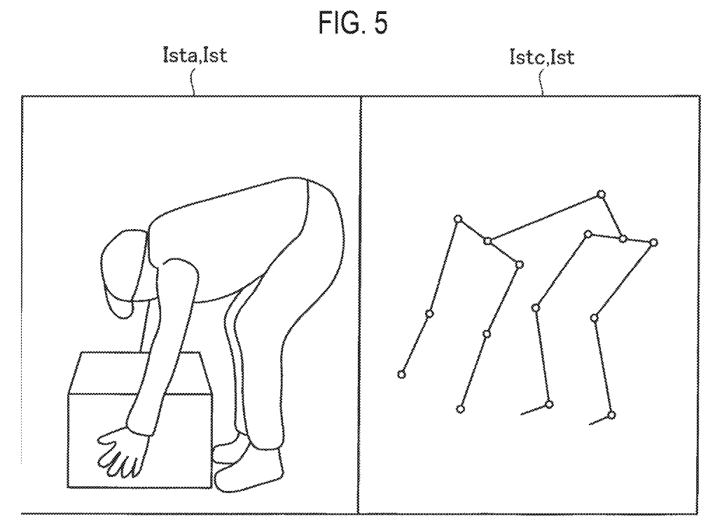

FIG. 5 is a diagram showing an example of the image displayed on the display unit 600 by the controller 900. FIG. 5 shows an example of the image displayed on the display unit 600 in a case where the user selects the above (i) and the above (vi). However, in FIG. 5, an image in a case where a work different from the work in the example of FIG. 4 is performed is shown. The work shown in FIG. 5 is a work of moving a box.

FIG. 5 shows a state image Ist representing the external shape state that is generated based on the output of the second sensor device 200. More specifically, in a left portion of FIG. 5, an image Ista captured by the process camera 210 is shown as the state image Ist. In a right portion of FIG. 5, a skeleton display Istc of the worker WK that is generated based on the output of the workwear sensor 230, is shown as the state image Ist. The skeleton display is a display representing the position of each joint of the worker and a line corresponding to each part of the body and connecting each joint.

By performing such processing, the state image Ist has a feature different from a case where only the images Ista and Istb captured by the cameras 210 and 220 are used. The worker WK can check the image without being affected by the color or the pattern of the clothing, the shadow of the clothing, or the like. As a result, the external shape state of the body can be ascertained from the state image Ist. In addition, the work analysis using the Ovako Working Posture Analysis System (OWAS) method can also be performed based on the skeleton display. As a result, it is possible to easily reduce the work load of the worker WK and prevent diseases.

As described above, with the work support system 10 of the present embodiment, the worker WK can easily ascertain the magnitude and the direction of the force applied during the work through the display unit 600. As a result, in a case of performing a specific work, the worker WK can use the display of the display unit 600 as a reference for performing appropriate work. Therefore, it is possible to efficiently train the new worker WK who is not accustomed to the work.

B. Other Embodiments

### B1. Other Embodiment 1

(1) In the above-described embodiment, the process camera 210 as the second sensor device 200 is fixed to a column in the factory (see the upper left portion of FIG. 1). The chest camera 220 as the second sensor device 200 is fixed to the chest belt worn by the worker WK (see the middle left portion of FIG. 1). However, the second sensor device 200 may be disposed at other parts such as a wall of the factory, a helmet worn by the worker WK, or goggles.
(2) In the above-described embodiment, only one camera is shown as the process camera 210 (see the upper left portion of FIG. 1). However, in the work support system 10, two or more cameras may be disposed as the process camera 210. Then, the images captured by the plurality of process cameras 210 may be switched and displayed on the display unit 600. In addition, the work support system 10 may be configured to display, on the display unit 600, an image of the worker WK as viewed from any angle designated by the user based on the images captured by the number of process cameras 210.
(3) In the above-described embodiment, the process camera 210 and the chest camera 220 as the second sensor device 200 are digital video cameras (see the upper left portion and the middle left portion of FIG. 1). However, the second sensor device may be a digital still camera capable of continuous imaging.
(4) In the above-described embodiment, wireless communication is performed between the first sensor device 100, the second sensor device 200, the third sensor device 300, and the controller 900. However, communication via wire may be performed between one or more of the first sensor device 100, the second sensor device 200, and the third sensor device 300, and the controller 900.
(5) In the above-described embodiment, the orientation images ItlDa and ItlDb representing the orientation of the tool held by the hand of the worker WK are displayed as the force image Ifc representing the direction of the force acting on the body of the worker (see the right portion of FIG. 4). However, the controller 900 may determine the magnitude and the direction of the resultant force acting on the body of the worker based on each detection value detected by the first sensor device 100, and display the force image Ifc based on these. For example, in an aspect in which a small IMU is attached to the finger of the worker together with the pressure sensor, the magnitude and the direction of the resultant force can be calculated based on the orientation of each finger detected by the IMU and the magnitude of the force on each finger detected by the pressure sensor.
(6) In the above-described embodiment, the skeleton display Istc is determined based on the output of the workwear sensor 230 (see the right portion of FIG. 5). However, the skeleton display Istc may be determined based on the image of the worker WK acquired by the process camera 210. In addition, the skeleton display Istc may be determined based on the image of the worker WK acquired by the process camera 210 and the output of the workwear sensor 230.
(7) In the above-described embodiment, the force image Ifcb including the circles Ifc1, Ifc2, and Ifc3 having a size corresponding to the magnitude of the force is displayed as the force image Ifc representing the magnitude of the force acting on the body of the worker WK, together with the still image of the hand (see the right portion of FIG. 3). In the above-described embodiment, the force image Ifcb including the circles Ifc1, Ifc2, and Ifc3 having a size corresponding to the magnitude of the force is used as the force image Ifc representing the magnitude of the force acting on the body of the worker WK. The force image Ifcb is displayed together with the still image of the hand (see the right portion of FIG. 3). However, the still image of the hand may not be displayed. However, it is preferable that the image representing the magnitude of the force is displayed to indicate which part of the body of the worker WK the force is applied to.
(8) In the above-described embodiment, the force image Ifcb including the circles Ifc1, Ifc2, and Ifc3 having a size corresponding to the magnitude of the force is displayed as the force image Ifc representing the magnitude of the force acting on the body of the worker (see the right portion of FIG. 3). However, the image having a size corresponding to the magnitude of the force may have a shape other than the circle, such as a triangle or a quadrangle, or may be an image including a pattern or a character.
(9) In the above-described embodiment, the force image Ifcb including the circles Ifc1, Ifc2, and Ifc3 having a size corresponding to the magnitude of the force is displayed as the force image Ifc representing the magnitude of the force acting on the body of the worker (see the right portion of FIG. 3). However, the image displayed in response to the magnitude of the force may be an image having a color corresponding to the magnitude of the force. For example, the image may have a color closer to red as the force is larger and a color closer to blue as the force is smaller. In addition, the image displayed in response to the magnitude of the force may be an image having a size and a color corresponding to the magnitude of the force.
(10) In the above-described embodiment, the images ItlDta and ItlDtb are shown as the images showing the ideal inclination of the electric driver (see the middle center portion of FIG. 4). The lines RLa and RLb that are images showing the vertical direction, are shown (see the middle center portion and the middle right portion of FIG. 4). The numerical values Da and Db are shown as the images showing the magnitude of the ideal inclination of the electric driver from the vertical direction (see the lower center portion and the lower right portion of FIG. 4). However, instead of these displays, the deviation of the actual inclination of the electric driver from the ideal inclination of the electric driver in each direction may be displayed as an image and/or a numerical value.
(11) In the above-described embodiment, the display of the force image representing the magnitude of the force acting on the body of the worker WK in the above (iii) and the display of the force image representing the direction of the force acting on the body of the worker WK in the above (iv) are possible. All of these are optionally selected by the user (see FIGS. 4 to 6). However, the controller 900 may be configured to display only one of the force image representing the magnitude of the force acting on the body and the force image representing the direction of the force acting on the body. In addition, the controller 900 may be configured to display both the force image representing the magnitude of the force acting on the body and the force image representing the direction of the force acting on the body.
(12) In the above-described embodiment, the display of the force image determined based on the output of the first sensor device 100 and the display of the state image determined based on the output of the second sensor device 200 are possible. All of these are optionally selected by the user (see FIGS. 4 to 6). However, the controller 900 may be configured to display only one of the force image determined based on the output of the first sensor device and the state image determined based on the output of the second sensor device. In addition, the controller 900 may be configured to display both the force image determined based on the output of the first sensor device and the state image determined based on the output of the second sensor device.
(13) In the above-described embodiment, in a case where the above (iv) is selected, the numerical values Da and Db are shown as the images showing the magnitude of the ideal inclination of the electric driver from the vertical direction (see the lower center portion and the lower right portion of FIG. 4). For example, on the display unit 600, for example, an evaluation value such as a burden on the waist and a bias of the center of gravity according to the OWAS method may be displayed together with the skeleton display Istc of the worker WK shown in FIG. 5.
(14) In the above-described embodiment, the displays illustrated in FIGS. 4 to 6 are described as being displayed on the display unit 600 after the work of the worker WK is completed. However, in the work support system, the worker WK may wear a head-mounted display, and in the head-mounted display, the displays of (i) to (vi) may be selectively performed during the work.
(15) In the above-described embodiment, in a case where the user selects the above (ii) as the display image, the state image Ist representing the external shape state is shown. The image Istb captured by the chest camera 220 is displayed as the state image Ist (see the lower left portion of FIG. 4). However, the controller 900 can also be configured to indicate the point at which the worker WK is looking in the image Istb captured by the chest camera 220.

In such an aspect, the second sensor device 200 further includes an eye-tracking camera that images both eyes of the worker WK. The eye-tracking camera may be mounted on the head of the worker WK or may be disposed at a position corresponding to the front of the worker WK during the work. The controller 900 specifies the point at which the worker WK is looking in a three-dimensional space based on the image of both eyes of the worker WK captured by the eye-tracking camera. The controller 900 displays the specified point at which the worker WK is looking in a superimposed manner on the image Ista captured by the process camera 210.

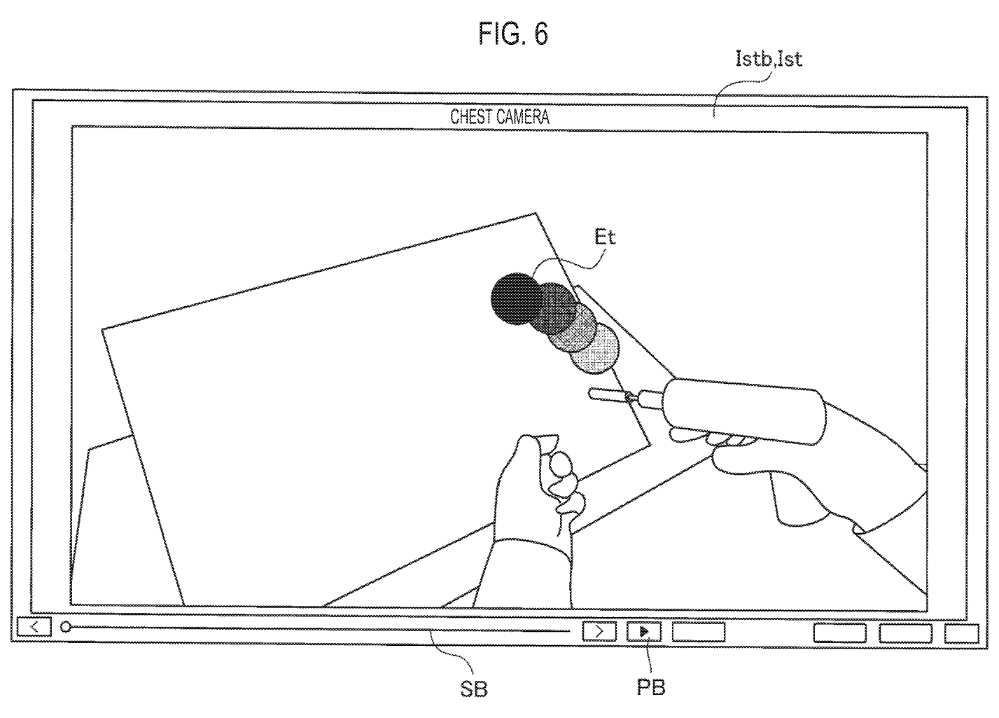

FIG. 6 is a diagram showing an aspect in which a point Et at which a worker WK is looking is displayed in a superimposed manner on an image Ista captured by a process camera 210 on the display unit 600. In the example of FIG. 6, the point at which the worker WK has looked in the past is displayed in a light color as time elapses, and the point at which the worker WK has looked for a certain time or longer is not displayed.

By performing such processing, the worker WK can easily ascertain the transition of the point at which the worker WK is looking during the work through the display unit 600. As a result, the worker WK can use the display of the display unit 600 as a reference for paying attention to an appropriate point during the work.

### B2. Other Embodiment 2

In the above-described embodiment, in a case where the above (iii) is selected, the force image Ifc representing the magnitude of the force acting on the body of the worker WK is used. The force image Ifc is a force image Ifcb including circles Ifc1, Ifc2, and Ifc3 having a size corresponding to the magnitude of the force. The force image Ifcb is displayed on the display unit (see the right portion of FIG. 3). However, the controller 900 can also be configured to be unable to display the circles Ifc1, Ifc2, and Ifc3 having a size corresponding to the magnitude of the force. For example, the controller 900 may display a numerical value corresponding to the magnitude of the force.

### B3. Other Embodiment 3

In the above-described embodiment, in a case where the above (iv) is selected, the orientation images ItlDa and ItlDb representing the orientation of the tool held by the hand of the worker WK are used. In addition, the target images ItlDta and ItlDtb representing the target of the orientation of the tool are also used. These images are displayed on the display unit (see the right portion of FIG. 4). However, the controller 900 can also be configured to be unable to display the target images ItlDta and ItlDtb. Further, the controller 900 can also be configured to be unable to display the target images ItlDta and ItlDtb and the orientation images ItlDa and ItlDb representing the orientation of the tool. In such an aspect, for example, the direction of the resultant force acting on the body of the worker may be determined based on each detection value detected by the first sensor device 100, and the force image Ifc may be displayed based on the direction.

### B4. Other Embodiment 4

In the above-described embodiment, in a case where the above (iv) is selected, the skeleton display Istc of the worker WK that is generated based on the output of the workwear sensor 230, is shown as the state image Ist (see the right portion of FIG. 5). However, the controller 900 can also be configured to be unable to display the skeleton display Istc of the worker WK. In such an aspect, for example, the image Ista captured by the process camera 210 may be shown.

The present disclosure is not limited to the above-described embodiments, and can be implemented with various configurations without departing from the gist of the present disclosure. For example, the technical features of the embodiment corresponding to the technical features in each aspect described in the section of “Summary” can be appropriately replaced or combined to solve some or all of the above-described problems. Alternatively, some or all of the above-described effects can be achieved by appropriately replacing or combining the technical features. In a case where the technical features are not described as being always needed in the present specification, the features can be deleted as appropriate.

What is claimed is:

1. A work support system comprising:
a first sensor device configured to acquire a magnitude of a force acting on a body of a worker;
a second sensor device configured to acquire an external shape state of a part of the body on which the force acts;
a display unit configured to display an image; and
a controller configured to control the work support system,
wherein the controller is configured to display, on the display unit,
a state image representing the external shape state, the state image being generated based on an output of the second sensor device, and
a force image representing at least one of a magnitude of the force acting on the body of the worker determined based on an output of the first sensor device and a direction of the force acting on the body of the worker determined based on the output of the second sensor device.

2. The work support system according to claim 1, wherein the controller is configured to display, on the display unit, an image having at least one of a size corresponding to the magnitude of the force and a color corresponding to the magnitude of the force, as the force image.

3. The work support system according to claim 1, wherein:
the second sensor device includes a camera configured to image a predetermined range including a hand of the worker; and
the controller is configured to simultaneously display, on the display unit,
an image captured by the second sensor device as the state image,
an orientation image representing an orientation of a tool held by the hand of the worker as the force image, and
a target image representing a target of the orientation of the tool.

4. The work support system according to claim 1, wherein:
the second sensor device includes a plurality of acceleration sensors attached to clothing worn by the worker; and
the controller is configured to display, on the display unit, a skeleton display of the worker generated based on the output of the second sensor device, as the state image.
